(19) United States
(12) Patent Application Publication
(10) Pub. No.: US 2006/0118539 A1
(43) Pub. Date: Jun. 8, 2006

(54) System and method for thermal management in a device

(75) Inventor: Gustavo D. Leizerovich, Aventura, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(73) Assignee: Motorola, Inc.

(21) Appl. No.: 11/002,499

(22) Filed: Dec. 2, 2004

(51) Int. Cl. H05B 3/00; H05B 1/00; H05B 11/00

(52) U.S. Cl. 219/209

(57) ABSTRACT

A system and method for reducing the size of a communication device in which a temperature-sensitive, non-heat generating component (302) is placed in close proximity to a heat generating component (304). The temperature of the non-heat generating component (302) is sensed to provide a sensed temperature. The operation of the heat generating component (304) is altered to avoid an over temperature condition of the non-heat generating component (302) based upon the sensed temperature.

### FIELD OF THE INVENTION

The field of the invention generally relates to electrical devices having heat generating and heat sensitive components. More specifically, the invention relates to minimizing the heat produced within these devices.

### BACKGROUND

The ability to combine and place many electrical components into a small package is advantageous to producers of electronic communication equipment. For example, consumers often desire small cellular telephones, pagers, and other electronic communication devices. As is known, the size of the device is an important selling feature with small and compact devices often selling better than large and bulky devices.

Electronic communication devices such as cellular phones and pagers include a variety of electrical components from microprocessors to resistors. Many of these components produce some heat as the device operates. Some of the components produce more heat than others. For instance, cellular phones and similar devices usually include power amplifiers, which produce substantial amounts of heat when the device is operating.

Besides heat-producing components, electronic devices also often include heat-sensitive components. The operation of these elements may be adversely affected by excessive heat created by the heat-producing components. For instance, surface acoustic wave (SAW) filters as are often used in electronic communication equipment are temperature sensitive devices and typically operate only up to +70° C. to +85° C. Heat dissipation of other components, for example, radio frequency power amplifier (RFPA) can and will raise the temperature of such SAW filters. As the temperature rises, the performance of the SAW filter is adversely affected. If the temperature rises to an extreme level, the SAW filter may become inoperable.

Previous systems have attempted to resolve this problem by placing heat producing components as far away as possible from heat-producing components. This approach, however, prevents the reduction-in-size of the electrical device because as the spacing increases, the size of the device also increases.

### BRIEF DESCRIPTION OF THE DRAWINGS

FIG. 1 is a block diagram of a small electrical device that manages thermal conditions according to the present invention;

FIG. 2 is flow chart of the operation of the microprocessor 138 shown in FIG. 1 according to the present invention; and

FIG. 3 is an assembly drawing of a small electrical device that manages thermal conditions according to the present invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF THE PREFERRED EMBODIMENTS

Heat-sensitive and heat producing components are placed in close proximity to each other within a small device. In other words, the components are close enough that heat generated by the one component is experienced by another component. The close placement of these components facilitates the design and use of smaller communication and other devices, such as mobile wireless devices and the like.

In one approach, a temperature-sensitive, non-heat generating component is placed in close proximity to a heat generating component. The temperature of the non-heat generating component is sensed to provide a sensed temperature. The operation of the heat generating component is altered to avoid an over-temperature condition of the non-heat generating component based upon the sensed temperature.

Pursuant to a preferred approach, the temperature-sensitive component may be a surface acoustic wave (SAW) element and the heat-generating component may be a radio frequency power amplifier (RFPA). Other types of devices may also be used.

The alteration of operation of a heat-generating component may be caused by adjusting a power level of a transmitter module of the device. In another example, the alteration of operation may be caused by adjusting a duty cycle of a transmitter module of the device. In still another example, the alteration of operation may be caused by adjusting a charge current of a battery charger of the device.

In another approach, a compact-sized communication device includes a temperature-sensitive, non-heat generating component. A heat generating component is situated in close physical proximity to the temperature-sensitive, non-heat generating component. A temperature sensor is placed in proximity to the non-heat generating component. The device also includes a controller having an input coupled to the sensor and an operation controlling output provided to the heat generating component.

The heat generating component may again be an RFPA. The temperature sensitive, non-heat generating component may also again be a SAW filter. Other types of devices may also be used.

The device may also include a transmitter. The controller may alter the operation of the RFPA by adjusting a power level of the transmitter using the operation controlling output. In another approach, the controller may alter the operation of the RFPA by adjusting a duty cycle of a transmitter using the operation controlling output.

The device may also include a battery charger. The controller may alter the operation of the RFPA by adjusting the charge current of the battery charger.

Thus, a small, compact device is provided whereby heat-sensitive components may be placed in close proximity to heat producing components notwithstanding an inherent sensitivity of the former to produce heat by the later. The resultant device is compact and the components are not allowed to overheat and become damaged.

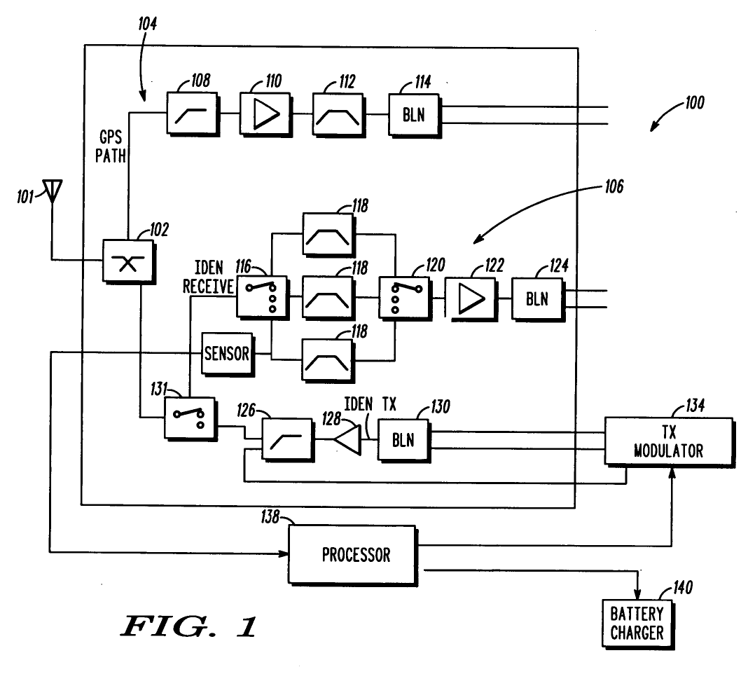

Referring now to FIG. 1, one example of a compact device which allows for the compact placement of heat producing and heat-sensitive components is described. It will be understood that the device described herein and its components are examples only and the nature, function, and exact components may vary.

In this illustrative embodiment, the wireless device 100 both receives global positioning satellite (GPS) signals and transmits and receives signals over a dispatch network, for example, the Integrated Dispatched Enhanced Network (iDEN®). As is know, iDEN is a high-capacity, digital trunked radio system providing integrated voice and data services to its users. In one example, the iDEN system uses digital modulation and speech coding techniques coupled with Time Division Multiple Access (TDMA) channel access methodology to enhance channel capacity and system services. Although shown in terms of GPS and iDEN paths, it will be understood by those skilled in the art that other types of communication paths may also be used.

The wireless device 100 includes a diplexer 102. The diplexer 102 receives and transmits combined signals via the antenna 101. The combined signals are signals being sent to or being received from a GPS path 104 and an iDEN path 106 of the device 100.

As shown, the GPS path 104 includes a high pass filter 108, low noise amplifier 110, SAW filter 112, and Balun 114. The GPS path 104 receives signals that are used by the system to locate the device 100. The processing of such signals is well known in the art and will not be described in further detail herein.

The iDEN path 106 includes a receive path. The receive path includes a switch 116, SAW filters 118, a switch 120, an amplifier 122 and a Balun 124. The Balun 124 receives two signals as inputs and creates one signal as an output. The use of these components is known, and will not be described further herein.

The iDEN path 106 also including a transmit path. The transmit path includes a low pass filter 126, an RF power amplifier 128 and a Balun 130. The Balun 130 is also coupled to a transmit (TX) modulator 134. Again, the use of these components is known, and will not be described herein.

Both the transmit and receive paths are coupled to the transmit receive switch 131. The transmit receive switch 131 determines whether the transmitter receive path is being used. The switch 131 is controlled by the microprocessor 138.

A temperature sensor 136 is coupled to microprocessor 138. This microprocessor 138 is coupled to the TX modulator 134 and a battery charger 140. The microprocessor 138 is responsible for determining actions to alter or otherwise mitigate or reduce the heat created by heat-generating components in the device 100.

The sensor 136 measures the temperature of the SAW filters 112 and 118. The information is transmitted to the microprocessor 138. The microprocessor 138 receives and processes this information. If an over-temperature condition at any of the monitored devices is determined to exist, the microprocessor 138 takes an appropriate action to prevent the component from overheating or otherwise becoming damaged because of excessive heat in the system.

In one approach, the microprocessor 138 acts upon the transmitting power of duty cycle of the TX modulator 134 to reduce the dissipated heat. If there are significant other sources of heat, these sources can be acted upon as well. For example, the charge field effect transistor (FET) can be acted upon where the battery current is reduced to maintain the SAW filters 112 and 118 under the operating range of the SAW filters 112 and 118.

In another approach the microprocessor 138 alters the power level of the TX modulator 134. By altering the transmitting power, the dissipated heat produced by the RFPA 128 is also adjusted.

The microprocessor 138 is also provided feedback in real time for its actions. Specifically, the sensor, as described above, is coupled to the microprocessor 138. Thus, the microprocessor 138 can monitor the actual heat reduction and can perform finer adjustments as needed.

The adjustments made by the microprocessor 138 may be determined using a variety of algorithms and approaches. For example, a linear relationship may exist between the excess temperature and the required action. For example, if the excess heat is 10 degrees, it may be required to reduce the output power by 1 dB. In another example, if a 25 degree reduction is required, it may be required to reduce the transmitter output power by 3 dB. A table or chart may be maintained by the microprocessor 138 for that purpose. Alternatively, other algorithms and relationships may be used to determine the parameter adjustments to make.

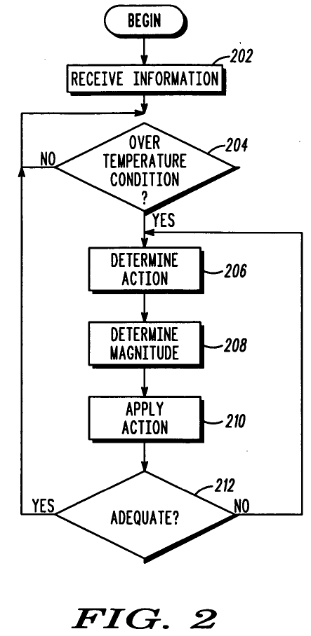

Referring now to FIG. 2, one example of an algorithm used at the microprocessor 138 is described. At step 202, the microprocessor 138 receives temperature information from the temperature sensor. At step 204, the microprocessor 138 determines whether the information it has received constitutes an over-temperature condition. If the answer is negative at step 204, control continues at step 202. If the answer is affirmative at step 204, then control continues at step 206.

At step 206, the microprocessor 138 determines the action to take. For example, under certain conditions it may seek to reduce the power of a transmitter 134. In other conditions, it may seek to reduce the duty cycle of the transmitter 134. In other cases it may seek to reduce the supply current of the battery charger 140. In other cases, it may perform two or all three of these actions. In addition to these actions, other types of actions that have the same effect of reducing heat in the system are possible.

At step 208, the microprocessor 138 determines the magnitude of the action to take. For example, if the action is reducing the duty cycle, the microprocessor 138 determines the amount to reduce the duty cycle. In another example, if the action is reducing the power of the transmitter 134, the microprocessor 138 determines the amount to reduce the power. In still another example, if the action to take is reducing the supply current, the microprocessor 138 determines the amount by which to reduce the supply current.

As described above, various algorithms can be applied to determine the magnitude of the action. In one example, a linear relationship between excess heat and magnitude of action may be used to determine the magnitude of the action based upon the magnitude of the over-temperature condition. However, other types of relationships may also be used.

At step 210, the microprocessor applies the action to the component. For example, the microprocessor may reduce the power of the transmitter 134, reduce the duty cycle of the transmitter 134, or reduce the supply current of the battery charger 140. At step 212, the microprocessor again monitors the output of the sensor and determines whether the appropriate temperature reduction has been achieved. If it has, control returns to step 202. If the result is that further action is required, control returns to step 208 where further adjustments may be made as described above.

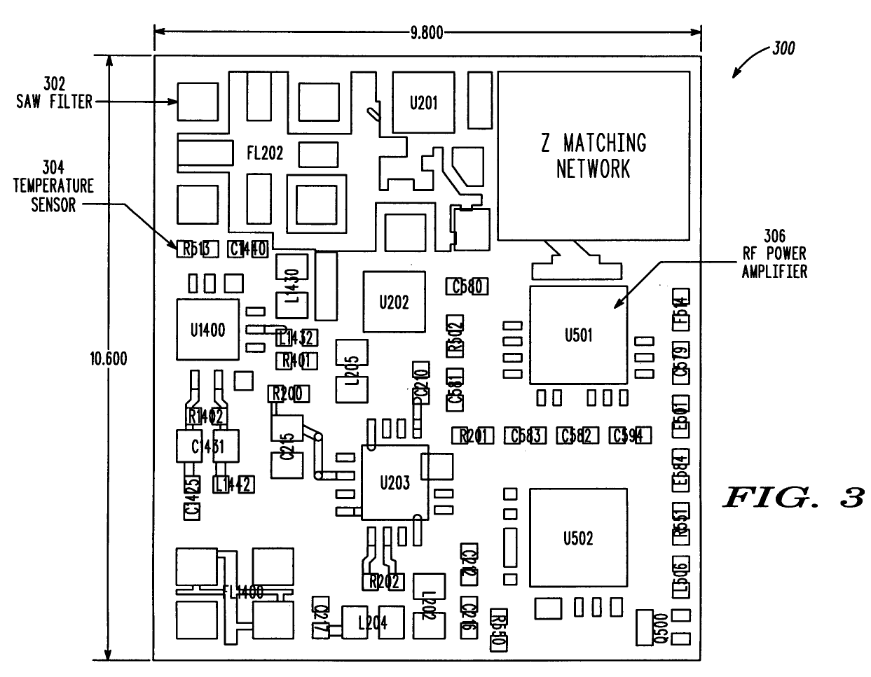

Referring now to FIG. 3, one example of an RF front end module 300 illustrating the small dimensions of a device achieved using the present approach is described. The module 300 is used in a small device, for example, a small wireless communication device. The module 300 includes a SAW filter 302, temperature sensors 304, and an RF power amplifier 306. The module 300 measures 10.6 by 9.8 millimeters. The sensors 304 are placed very closely to the SAW filter 302, for example, within 2mm of the SAW filter 302. The SAW filter 302 is placed within 6.5 mm of the RF power amplifier 306. As has been described above, a temperature-sensitive, non-heat generating component (SAW filter 302) is placed in close proximity to a heat generating component (RF power amplifier 306). In other words, the components are close enough that heat generated by the RF power amplifier 306 is experienced by the SAW filter 302. The temperature of the SAW filter 302 is sensed to provide a sensed temperature. The operation of the RF power amplifier 306 is altered to avoid an over-temperature condition of the SAW filter 302 based upon the sensed temperature. Consequently, the SAW filter 302 and the RF power amplifier 306 are placed in close proximity to each other. By being placed in close proximity to each other, the size of the board 300 that is placed within a device is greatly reduced. And, because of the close placement, the size of the resultant device is also reduced.

While there have been illustrated and described particular embodiments of the present invention, it will be appreciated that numerous changes and modifications will occur to those skilled in the art, and it is intended in the appended claims to cover all those changes and modifications which fall within the true spirit and scope of the present invention.

1. A method for reducing the size of a communication device comprising:
placing a temperature-sensitive, non-heat generating component in close proximity to a heat generating component;
sensing the temperature of the non-heat generating component to provide a sensed temperature; and
altering the operation of the heat generating component to avoid an over-temperature condition of the non-heat generating component based upon the sensed temperature.

2. The method of claim 1 wherein placing a temperature sensitive, non-heat generating component in close proximity to a heat generating component comprises placing a surface acoustic wave (SAW) filter in close proximity to a radio frequency power amplifier (RFPA).

3. The method of claim 1 wherein the step of altering the operation comprises adjusting a power level of a transmitter module of the device.

4. The method of claim 1 wherein the step of altering the operation comprises altering a duty cycle of a transmitter module of the device.

5. The method of claim 1 wherein the step of altering the operation comprises adjusting a charge current of a battery charger of the device.

6. A compact-sized communication device comprising:
a temperature-sensitive, non-heat generating component;
a heat generating component in close physical proximity to the temperature-sensitive, non-heat generating component;
a temperature sensor in proximity to the non-heat generating component; and
a controller having an input coupled to the sensor and an operation controlling output to the and heat generating component.

7. The device of claim 6 wherein the heat generating component is a RFPA.

8. The device of claim 6 wherein the temperature sensitive, non-heat generating component is a SAW filter.

9. The device of claim 6 further comprising a transmitter and wherein the controller alters operation of the RFPA by adjusting a power level of the transmitter using the operation controlling output.

10. The device of claim 6 further comprising a transmitter and wherein the controller alters the operation of the RFPA by adjusting a duty cycle of a transmitter using the operation controlling output.

11. The device of claim 6 further comprising a battery charger and wherein the controller alters the operation by adjusting the charge current of the battery charger.

12. A method for reducing the size of a transmitter module comprising:
placing an RFPA in close physical proximity to a SAW filter;
placing a sensor in proximity to the SAW filter;
using the sensor to determine a temperature of the SAW filter;
altering operation of the RFPA to avoid an over-temperature condition at the SAW filter.

13. The method of claim 12, wherein the step of altering operation comprises adjusting a power level of a transmitter, the transmitter in part controlling operation of the RFPA.

14. The method of claim 12, wherein the step of altering the operation comprises altering the duty cycle of a transmitter, the transmitter in part controlling the operation of the RFPA.

15. The method of claim 12, wherein the step of altering the operation comprises adjusting a charge current of a battery charger.

16. A method for reducing the size of a transmitter module comprising:
placing an RFPA near a SAW filter in the transmitter module such that the SAW filter experiences heat generated by the RFPA;
placing a sensor in proximity to the SAW filter;
using the sensor to determine a temperature of the SAW filter;
altering operation of the RFPA to avoid an over-temperature condition at the SAW filter.

17. The method of claim 16, wherein the step of altering operation comprises adjusting a power level of a transmitter, the transmitter in part controlling operation of the RFPA.

18. The method of claim 16, wherein the step of altering the operation comprises altering the duty cycle of a transmitter, the transmitter in part controlling the operation of the RFPA.

19. The method of claim 16, wherein the step of altering the operation comprises adjusting a charge current of a battery charger.
